(19) United States
(12) Patent Application Publication
(10) Pub. No.: US 2018/0059917 A1
(43) Pub. Date: Mar. 1, 2018

(54) INFORMATION PROCESSING APPARATUS, INFORMATION PROCESSING SYSTEM, AND INFORMATION PROCESSING METHOD

(71) Applicant: Ken TAKEHARA, Kanagawa (JP)

(72) Inventor: Ken TAKEHARA, Kanagawa (JP)

(73) Assignee: Ricoh Company, Ltd., Tokyo (JP)

(21) Appl. No.: 15/672,370

(22) Filed: Aug. 9, 2017

(30) Foreign Application Priority Data
Aug. 23, 2016 (JP) 2016-162889

(51) Int. Cl. G06F 3/0484; G06F 3/12

(52) U.S. Cl. CPC G06F 3/04845; G06F 3/04842; G06F 3/125; G06F 2203/04803; G06F 3/1211

(57) ABSTRACT

An information processing apparatus, information processing system, and information processing method, each of which: stores, in a first memory, first association information that associates with one another group identification information for identifying a group, application identification information for identifying an application, first data not encrypted, and second data obtained by encrypting the first data by using an encryption key based on the group identification information; selects, in response to receiving a search request including the application identification information and a search key representing a character string to he searched for, the second data associated with a set of the application identification information included in the search request and the first data that matches the search key included in the search request; decrypt the selected second data by using the encryption key based on the group identification information to obtain decrypted data; and transmits the decrypted data as a response to the search request.

### CROSS-REFERENCE TO RELATED APPLICATIONS

This patent application is based on and claims priority pursuant to 35 U.S.C. § 119(a) to Japanese Patent Application No. 2016-162889, filed on Aug. 23, 2016, in the Japan Patent Office, the entire disclosure of which is hereby incorporated by reference herein.

### BACKGROUND

### Technical Field

The present invention relates to an information processing apparatus, an information processing system, and an information processing method.

### Description of the Related Art

In the related art, techniques are known which allow a cloud system that provides cloud-computing-based services to provide such services to apparatuses for example, image processing apparatuses) having a function for enabling cloud computing.

For example, a server that provides a service in such a cloud system usually creates, for each group (tenant) that is a unit in which the service is provided, a database for storing data used by an application which the group is permitted to use. Such a configuration, however, can make data management complex. Accordingly, for example, a method for collectively managing data of the groups in a single database is conceivable.

However, the aforementioned configuration in which data of the groups is collectively managed in a single database involves a risk of not only data including a search key but also all the data regarding all the groups leaking to the outside because of an invalid operation performed during a data search using Structured Query Language (SQL) or the like.

### SUMMARY

Example embodiments of the present invention include an information processing apparatus, information processing system, and information processing method, each of which: stores, in a first memory, first association information that associates with one another group identification information for identifying a group, application identification information for identifying an application, first data not encrypted, and second data obtained by encrypting the first data by using an encryption key based on the group identification information; selects, in response to receiving a search request including the application identification information and a search key representing a character string to be searched for, the second data associated with a set of the application identification information included in the search request and the first data that matches the search key included in the search request; decrypt the selected second data by using the encryption key based on the group identification information to obtain decrypted data; and transmits the decrypted data as a response to the search request.

Example embodiments of the present invention include a non-transitory recording medium storing a program for performing the above-described information processing method.

### BRIEF DESCRIPTION OF THE SEVERAL VIEWS OF THE DRAWINGS

A more complete appreciation of the disclosure and many of the attendant advantages and features thereof can be readily obtained and understood from the following detailed description with reference to the accompanying drawings, wherein:

FIG. 1 is a diagram illustrating an example of a configuration of a system according to an embodiment;

FIG. 2 is a diagram illustrating an example of a hardware configuration of a server;

FIG. 3 is a diagram illustrating an example of functions of the server;

FIG. 4 is a diagram illustrating an example of user association information;

FIG. 5 is a diagram illustrating an example of application association information;

FIG. 6 is a diagram illustrating an example of application data;

FIG. 7 is a sequence diagram illustrating an example of a procedure of an operation performed by the system;

FIG. 8 is a diagram illustrating an example of a login screen;

FIG. 9 is a diagram illustrating an example of an initial screen;

FIG. 10 is a sequence diagram illustrating an example of a procedure of an operation performed by the system;

FIG. 11 is a diagram illustrating an example of a record addition screen;

FIG. 12 is a sequence diagram illustrating an example of a procedure of an operation performed by the system;

FIG. 13 is a diagram illustrating an example of an update screen;

FIG. 14 is a sequence diagram illustrating an example of a procedure of an operation performed by the system; and

FIG. 15 is a diagram illustrating an example of a data search screen.

The accompanying drawings are intended to depict embodiments of the present invention and should not be interpreted to limit the scope thereof. The accompanying drawings are not to be considered as drawn to scale unless explicitly noted.

### DETAILED DESCRIPTION

The terminology used herein is for the purpose of describing particular embodiments only and is not intended to be limiting of the present invention. As used herein, the singular forms “a”, “an” and “the” are intended to include the plural forms as well, unless the context clearly indicates otherwise.

In describing embodiments illustrated in the drawings, specific terminology is employed for the sake of clarity. However, the disclosure of this specification is not intended to be limited to the specific terminology so selected and it is to be understood that each specific element includes all technical equivalents that have a similar function, operate in a similar manner, and achieve a similar result.

An information processing apparatus, an information processing system, an information processing method, and a program according to embodiments of the present invention will be described in detail below with reference to the accompanying drawings.

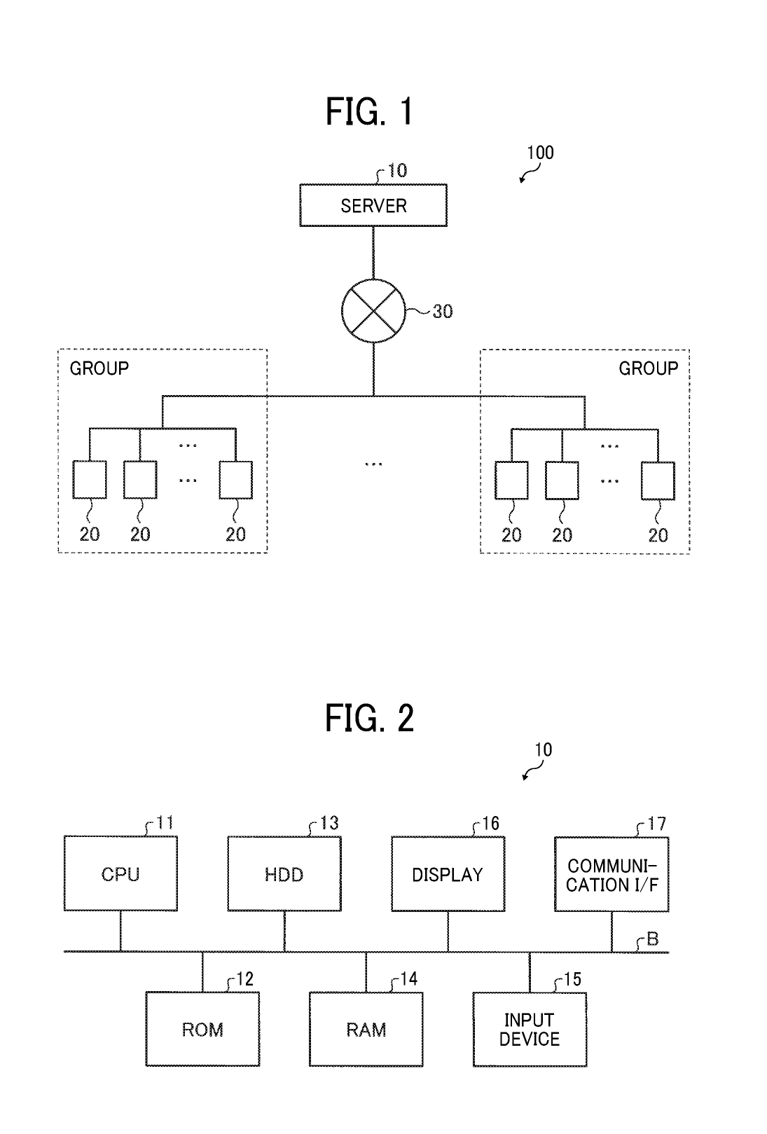

FIG. 1 is a diagram illustrating an example of a configuration of a system 100 according to an embodiment. As illustrated in FIG. 1, the system 100 includes a server 10 and a plurality of terminals 20. The server 10 provides a cloud-computing-based service (hereinafter, referred to as a cloud service). The server 10 and the terminals 20 are connected to one another via a network 30, such as the Internet. In this example, the server 10 provides the cloud service in units of groups, which are units such as companies that carry out economic activities, for example. In the example illustrated in FIG. 1, each of the terminals 20 that belong to one of the groups has a function of communicating with the server 10 to acquire data and displaying the acquired data (web-user interface web-UI) function). Each of the terminals 20 may be, for example, a personal computer (PC) or a portable information processing terminal, such as a smart device or a tablet.

A configuration of the server 10, which is an example of an “information processing apparatus”, will be described next. Although the system 100 includes a single server 10 in the example illustrated in FIG. 1 for ease of explanation, the configuration is not limited to this one. The system 100 may include any given number of servers 10 (a plurality of servers 10).

FIG. 2 is a diagram illustrating an example of a hardware configuration of the server 10. As illustrated in FIG. 2, the server 10 includes a central processing unit (CPU) 11, a read-only memory (ROM) 12, a hard disk drive (HDD) 13, a random access memory (RAM) 14, an input device 15, a display 16, and a communication interface (I/F) 17, which are connected to one another via a bus B.

The CPU 11 is an arithmetical unit that reads a program and data from a storage device, such as the ROM 12 or the HDD 13, to the RAM 14 and executes a process, thereby controlling the entire server 10 and implementing various functions.

The ROM 12 is an example of a non-volatile semiconductor memory (storage device) capable of storing a program and data even when the power is off (even when power supply to the server 10 is cut). The ROM 12 stores a program such as a basic input/output system (BIOS) executed at the time of booting of the server 10 and data such as operating system (OS) configurations and network configurations.

The HDD 13 is an example of a non-volatile storage device that stores a program and data. The RAM 14 is an example of a volatile storage device that temporarily stores a program and data. The RAM 14 functions as a working area for a process executed by the CPU 11.

The input device 15 is a device used by the user to input various operation signals. For example, the input device 15 may be a keyboard and mouse or a touch panel. The display 16 is a device that displays various kinds of information (for example, a result of processing performed by the server 10 or the like). For example, the display 16 may be a liquid crystal display device. Note that the input device 15 and the display 16 may be integrated together just like a touch panel, for example. In addition, the input device 15 and the display 16 may be connected to the server 10 for use, when necessary.

The communication I/F 17 is an interface used to communicate with each of the terminals 20. In this example, the communication I/F 17 is an interface for connecting the server 10 to the network 30.

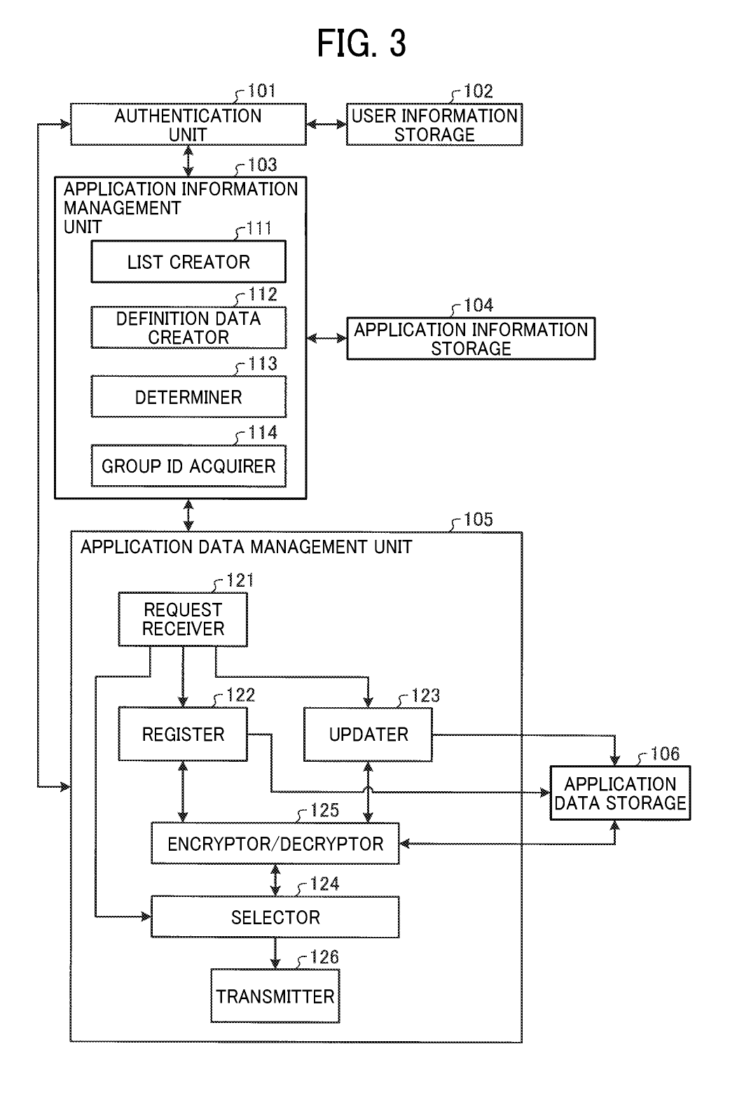

FIG. 3 is a diagram illustrating an example of functions of the server 10. As illustrated in FIG. 3, the server 10 includes an authentication unit 101, a user information storage 102, an application information management unit 103, an application information storage 104, an application data management unit 105, and an application data storage 106.

The authentication unit 101 performs authentication of each user by using user information stored in the user information storage 102. Specifically, the server 10 has a function of determining whether the user (the terminal 20 that has made an access) has a right to use the cloud service. It is assumed in this example that the cloud service provided by the server 10 is a service for setting or updating a plurality of pieces of data (pieces of data used by an application) by using the terminal 20 to easily create an application. However, the cloud service provided by the server 10 is not limited to this service. A detailed operation of the authentication unit 101 will be described later.

The user information storage 102 stores user information, for each user who has a right to use the cloud service. In this example, the user information refers to a combination of a user identifier (ID) and a password. However, the user information is not limited to this information.

The application information management unit 103 manages application information stored in the application information storage 104 and performs various processes using the application information. The application information storage 104 stores, for each of a plurality of applications, application information regarding the application, such as information from which a list (described later) is created and definition data (described later). As illustrated in FIG. 3, the application information management unit 103 includes a list creator 111, a definition data creator 112, a determiner 113, and a group ID acquirer 114.

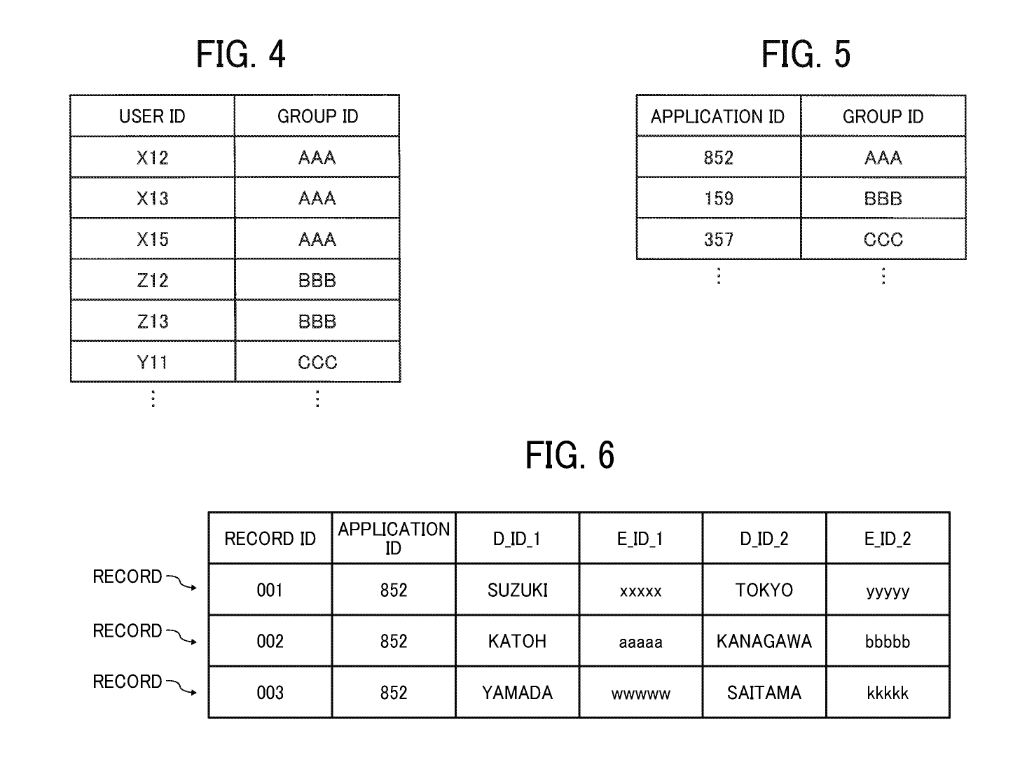

The list creator 111 creates a list of applications which the authenticated user is permitted to use. In this example, the list includes an application ID (an example of application identification information) for identifying an application and a name of the application (application name displayed on the screen). In this example, the application information storage 104 stores, for each of the plurality of applications, application information of the application, user association information, and group association information. The user association information is an example of “fourth association information”. The user association information is information that associates with each other a user ID and a group ID (an example of group identification information) for identifying a group to which the user identified by the user ID belongs. FIG. 4 is a diagram illustrating an example of the user association information. The application association information is an example of “second association information”. The application association information is information that associates with each other an application ID and a group ID for identifying a group that is permitted to use the application identified by the application ID. FIG. 5 is a diagram illustrating an example of the application association information. A detailed operation of the list creator 111 will be described later. In this example, it may be considered that the application information storage 104 functions as a “second memory”.

The definition data creator 112 creates definition data of an application selected on the screen of the terminal 20. The definition data of an application is data for generating a screen associated with the application and includes the application ID, the application name, an item list, screen layout information, etc. Elements included in the item list may be the item ID (item identification information) for identifying an item, the name of the item, and the type of the item, for example. A detailed operation of the definition data creator 112 will be described later.

The determiner 113 determines, for each of various requests (described later), whether a user who has made the request is permitted to use an application for which the request is made. A detailed operation of the determiner 113 will be described later. The group ID acquirer 114 acquires, for each of the various requests (described later), a group ID associated with the application for which the request is made. A detailed operation of the group ID acquirer 114 will be described later.

The application data management unit 105 manages application data stored in the application data storage 106 and performs various processes using the application data. In this example, the application data is an example of “third association information”. The application data is information that associates with one another, for each record that represents a unit of stored information, a record ID (an example of record identification information) for identifying the record, an application ID, first data not encrypted, and second data obtained by encrypting the first data by using an encryption key based on a group ID associated with the application ID.

In this example, the first data may be regarded as a set of an item and a value (entity of data not encrypted) or as the value not encrypted. Likewise, the second data may be regarded as a set of an item and a value (entity of encrypted data) or as the encrypted value. The encryption key used to encrypt the first data is generated based on the group ID associated in the above-described application association information (see FIG. 5) with the application ID of the application that uses the first data.

FIG. 6 is a diagram illustrating an example of the application data. In this example, the application data is information that associates, for each record, the record ID of the record, the application ID, data not encrypted, and encrypted data with one another. In the example illustrated in FIG. 6, a “record”, which is a set of pieces of information in each row, is information including the record ID, the application ID, the value of the item ID (illustrated as D_ID) for identifying the item of data not encrypted, and the value of the item ID (illustrated as E_ID) for identifying the item of encrypted data. The number of D_IDs and the number of E_ID) are determined depending on the number of pieces of data used by each application and can change in any way. In the example illustrated in FIG. 6, two D_IDs and two E_IDs are included. However, the numbers of D_IDs and E_IDs are not limited to this value. In addition, a numeral appended to D_ID and E_ID represents an association between D_ID and E_ID. That is, D_ID_1 and E_ID_1 are associated with each other, and D_ID_2 and E_ID_2 are associated with each other. For example, the state where D_ID_1 and E_ID_1 are associated with each other indicates that the value of E_ID_1 is a value obtained by encrypting the value of D_ID_1 by using an encryption key based on the group ID associated. with the corresponding application

In the example illustrated in FIG. 6, the application identified by the application ID “852” is an application for managing a customer list, D_ID_1 represents an item corresponding to the name not encrypted, and E_ID_1 represents an item corresponding to the encrypted name. That is, the value of D_ID₁₃ 1 represents the name not encrypted, and the value of E_ID_1 represents the encrypted name. In addition, D_ID_2 represents an item corresponding to an address not encrypted, and E_ID_2 represents an item corresponding to the encrypted address. That is, the value of D_ID_2 represents the address not encrypted, and the value of E_ID_2 represents the encrypted address. Note that any kinds and any numbers of application IDs, D_IDs, and E_IDs may be registered in the application data, and the kinds and the number may be unique to each record. In this embodiment, databases for managing data used by applications which respective groups are permitted to use are not created separately for the respective groups; instead, data utilized by the plurality of applications which respective groups are permitted to use is collectively managed by using the application data.

Although the server 10 according to the embodiment separately manages the application association information described above and the application data described, the configuration is not limited to this one. For example, the application association information described above and the application data described above may be integrated together, and the server 10 may manage the resultant information. That is, the server 10 is just required to include a first memory configured to store first association information that associates with one another a group ID, an application ID, first data not encrypted, second data obtained by encrypting the first data by using an encryption key based on the group ID. In the embodiment, a combination of the application information storage 104 that stores the application association information described above and the application data storage 106 that stores the application data described above functions as the “first memory”.

Referring back to FIG. 3, the description is continued. The application management unit 105 includes a request receiver 121, a register 122, an updater 123, a selector 124, an encryptor/decryptor 125, and a transmitter 126.

The request receiver 121 receives various requests from each of the terminals 20. Although a detailed description is given later, the request receiver 121 can receive a new registration request that requests registration of new data. The new registration request includes first data, an authentication token (user ID), and an application ID. The request receiver 121 can also receive an update request that requests updating of a record. The update request includes one or more pieces of first data, an authentication token (user ID), an application ID, and a record ID. The request receiver 121 can further receive a search request that at least includes an application ID and a search key indicating a character string be searched for. As described later, the search request further includes an authentication token (user ID) in this embodiment.

Communications performed between the application data management unit 105 and the authentication unit 101 and between the application data management unit 105 and the application information management unit 103 in response to the request receiver 121 receiving various requests will be described later.

In response to the request receiver 121 receiving the new registration request, the register 122 registers, as a new record in the application data (third association information), information that associates with one another first data included in the new registration request, second data obtained by encrypting the first data by using an encryption key based on a group ID associated with the application ID included in the new registration request, and a newly issued record ID of the record. A detailed operation of the register 122 will be described later.

In response to the request receiver 121 receiving the update request, the updater 123 updates the first data included in the record identified by the record ID included in the update request to the first data included in the update request and also updates the second data included in the record to the second data obtained by encrypting the updated first data by using an encryption key based on a group ID associated with the application ID included in the update request. A detailed operation of the updater 123 will be described later.

In response to the request receiver 121 receiving the search request, the selector 124 selects the second data that is associated with a combination of the application ID included in the search request and the first data that matches the search key included in the search request. More specifically, the selector 124 selects one or more records each including the application ID included in the search request and the first data that matches the search key included in the search request from the application data, and selects the second data (all the pieces of second data) included in the one or more selected records. A detailed operation of the selector 124 will be described later.

The encryptor/decryptor 125 encrypts or decrypts data in response to a request from each of the register 122, the updater 123, and the selector 124. The encryptor/decryptor 125 is an example of “circuitry” and has a function of decrypting the second data selected by the selector 124, by using an encryption key based on corresponding group identification information. Although a detailed description is given later, the application data management unit 105 causes the group ID acquirer 114 of the application information management unit 103 to acquire the group ID associated with the application ID included in the search request received by the request receiver 121. Then, the encryptor/decryptor 125 decrypts the second data selected by the selector 124 by using an encryption key based on the group ID acquired by the group ID acquirer 114. A detailed operation of the encryptor/decryptor 125 will be described later.

The transmitter 126 transmits, as a response to the search request, the decrypted data obtained by the encryptor/decryptor 125.

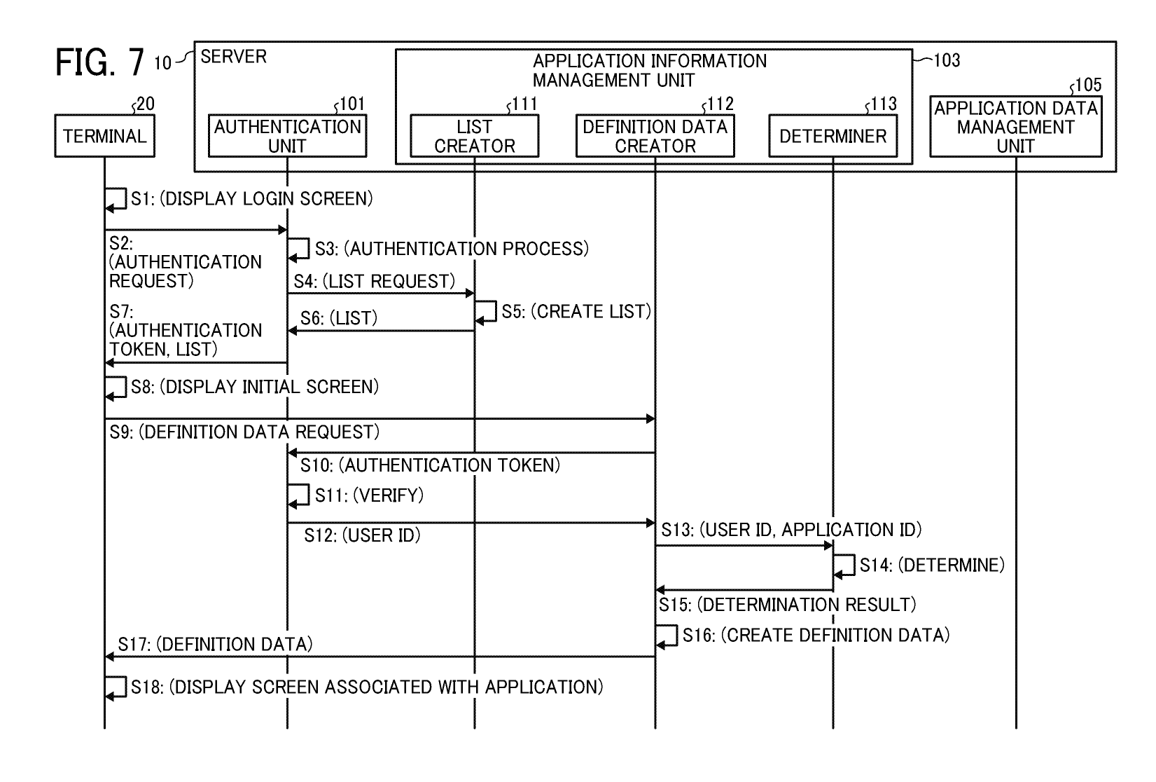

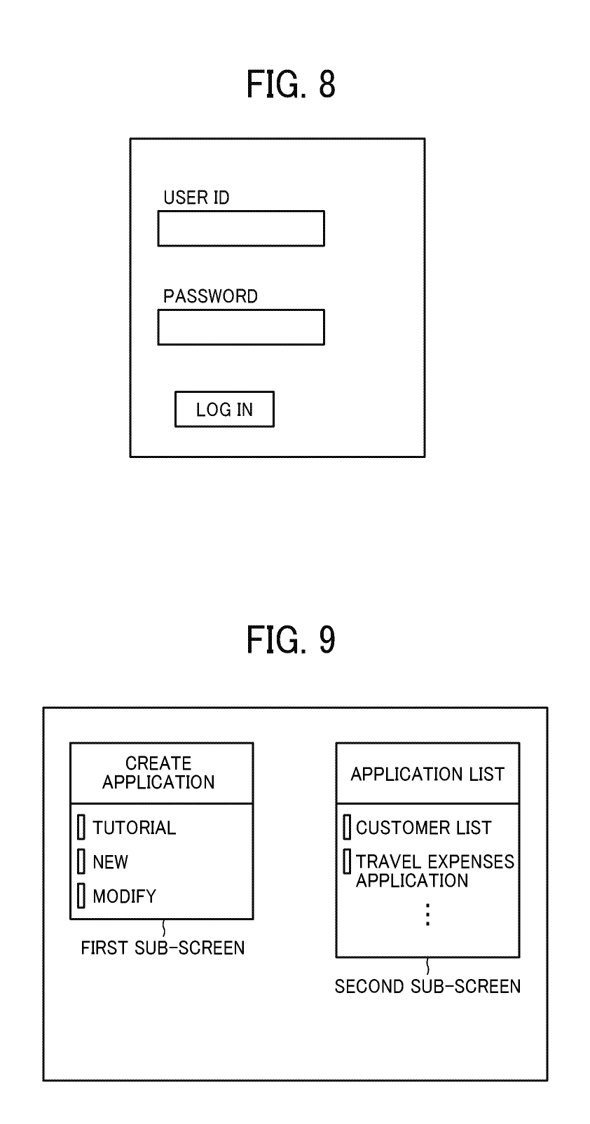

An example of a procedure of an operation performed by the system 10 from authentication of the user to display of a screen associated with an application selected by the user on the terminal 20 will be described next with reference to FIG. 7. In response to a user operation, the terminal 20 displays a login screen for authenticating whether the user has a right to receive the provided cloud service (step S1). FIG. 8 is a diagram illustrating an example of the login screen. Although fields for inputting the user ID and the password that are used in an authentication process and a login button for making a request to start the authentication process are displayed in the example illustrated in FIG. 8, the login screen is not limited to this screen.

The description of FIG. 7 is continued. Upon receiving pressing of the login button after the input of the user ID and the password on the login screen, the terminal 20 transmits to the server 10 an authentication request that includes the input user II) and the input password and that requests authentication of the user (step S2). The authentication unit 101 of the server 10 that has received the authentication request performs an authentication process to determine whether user information that matches a combination of the user ID and the password that are included in the authentication request is found in the plurality of pieces of user information (combinations of the user ID and the password) stored in the user information storage 102 (step S3). For ease of explanation, the description is given below of the case where the result of the authentication process in step S3 is positive (the user is successfully authenticated), for example. If the result of the authentication process in step S3 is positive, the authentication unit 101 issues (generates) an authentication token. In this example, the authentication token is information obtained by encrypting information including a one-time key that represents a unique key issued for every authentication and the user ID of the authenticated user. The authentication unit 101 also manages the issued authentication token.

Then, the authentication unit 101 supplies the user ID of the authenticated user to the application information management unit 103 to request a list of applications which the user identified by the user ID is permitted to use (step S4). The list creator 111 that has received this request creates a list (step S5). More specifically, the list creator 111 refers to the user association information (FIG. 4) described above and identifies the group ID associated with the user II) of the authenticated user. Then, the list creator 111 refers to the application association information (FIG. 5) described above and identifies all the application IDs associated with the identified group ID. Applications identified by the application IDs identified in this way are applications which the authenticated user is permitted to use. The list creator 111 creates a list including, for each of the applications which the authenticated user is permitted to use, at least the application ID and the application name by using the application information stored in the application information storage 104.

The list creator 111 returns the list created in step S5 to the authentication unit 101 (step S6). The authentication unit 101 transmits, to the terminal 20, the authentication token issued in step S3 and the list received from the list creator 111 (step S7). Then, the terminal 20 displays an initial screen, such as the one illustrated in FIG. 9, on the basis of the list received from the server 10 (step S8). Although the initial screen includes a first sub-screen for creating an application and a second sub-screen for displaying a list of applications in accordance with the list in the example illustrated in FIG. 9, the initial screen is not limited to this screen.

The description of FIG. 7 is continued. Upon receiving an input of selecting one of the applications on the initial screen (the second sub-screen in this example), the terminal 20 transmits, to the server 10, a definition data request that includes the application ID of the selected application and the authentication token received from the server 10 and that requests definition data of the application (step S9).

The definition data creator 112 that has received the definition data request supplies the authentication token included in the definition data request to the authentication unit 101 to request the authentication unit 101 to verify the authentication token (step S10). The authentication unit 101 decrypts the authentication token received from the definition data creator 112 and verifies whether the combination of the decrypted one-time key and user ID has been already issued (step S11). For ease of explanation, the description is given below of the case where the result of the verification in step S11 is positive, for example. The authentication unit 101 extracts the user ID from the decrypted authentication token and transmits the extracted user ID to the definition data creator 112 (step S12).

Then, the definition data creator 112 supplies the user ID received from the authentication unit 101 and the application ID included in the definition data request to the determiner 113 to request the determiner 113 to determine whether the user identified by the user ID is permitted to use the application identified by the application ID (step S13). The determiner 113 that has received this request determines whether the user identified by the user ID is permitted to use the application identified by the application ID, by using the user ID and the application ID supplied by the definition date creator 112 (step S14). More specifically, the determiner 113 refers to the user association information (FIG. 4) and identifies the group ID associated with the user ID supplied by the definition data creator 112. Then, the determiner 113 refers to the application association information (FIG. 5) and identifies one or more application Ds associated with the identified group ID. The determiner 113 then determines whether the application ID supplied by the definition data creator 112 is included in the identified application IDs. If the result of this determination is positive, the determiner 113 determines that the user identified by the user ID supplied by the definition data creator 112 is permitted to use the application identified by the application ID supplied by the definition data creator 112.

For ease of explanation, the description is given below of the case where the result of the determination in step S14 is positive, for example. The determiner 113 transmits the determination result of step S14 to the definition data creator 112 (step S15). The definition data creator 112 that has received this determination result (positive determination result in this case) creates definition data of the application identified by the application ID included in the definition data request, by using the application information stored in the application information storage 104 (step S16) and transmits the created definition data to the terminal 20 (step S17). The terminal 20 that has received this definition data creates a screen (screen associated with the application) based on the received definition data and displays the created screen (step S18).

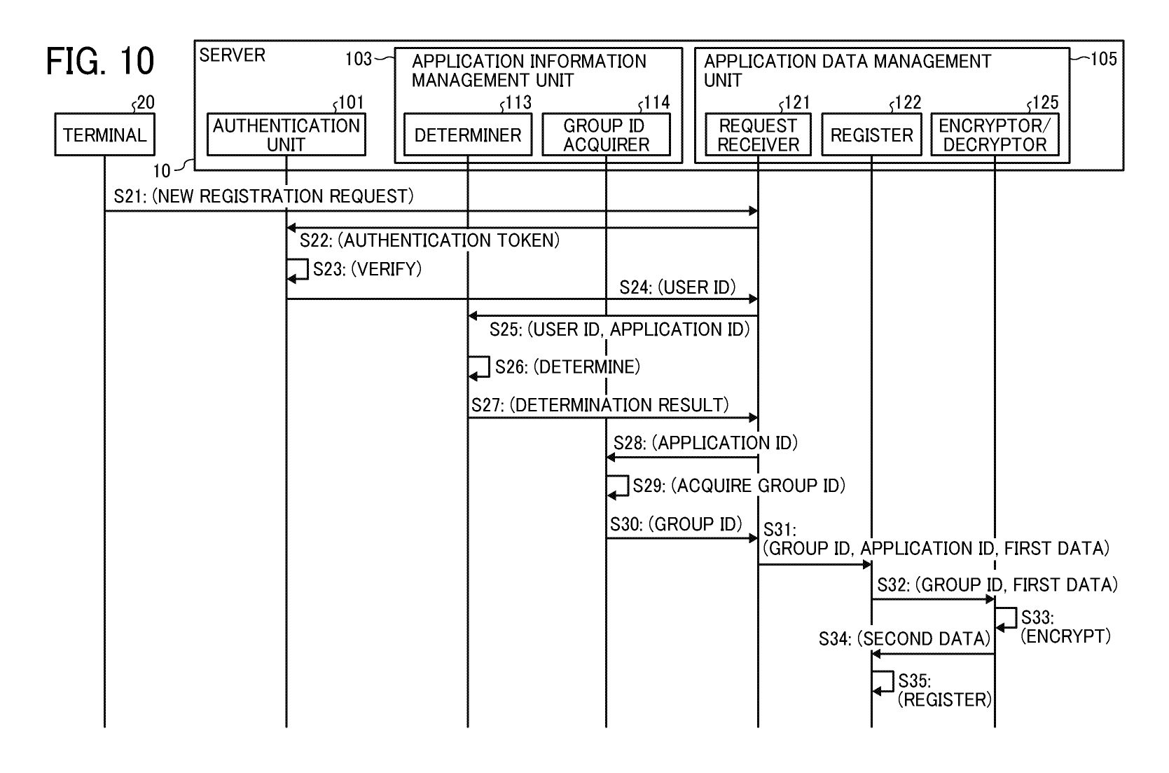

An example of a procedure of an operation performed by the system 100 in response to an authenticated user (user who has logged in) performing an operation for registering new data (data in unit of a record in this example) as data used by one of the applications will be described next with reference to FIG. 10.

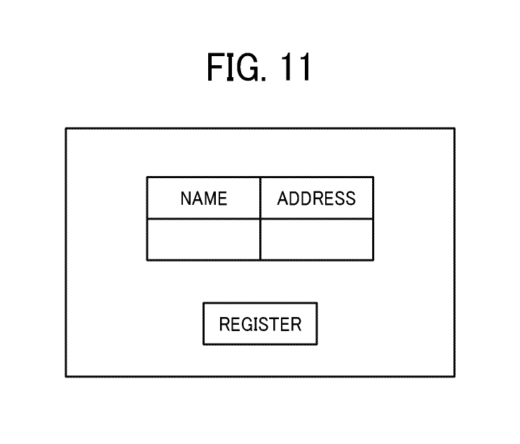

First, the authenticated user performs an operation for activing a record addition screen for adding a new record, on the screen associated with the application. The authenticated user then performs an operation for adding new values of respective items on the record addition screen and performs an operation for requesting registration of new data. For example, in the case of the application that manages the customer list, the user can perform an operation of inputting values of the respective items of “NAME” and “ADDRESS” on the record addition screen illustrated in FIG. 11 and then perform an operation of pressing a register button. The terminal 20 that has received this operation transmits, to the server 10, a new registration request that includes the input data (one or more pieces of first data each including a set of an item and a value), the authentication token (including the user ID) acquired from the server 10, and the application ID (of the one of the applications) (step S21).

The request receiver 121 of the server 10 that has received the new registration request supplies the authentication token included in the new registration request to the authentication unit 101 to request the authentication unit 101 to verify the authentication token (step S22). The authentication unit 101 decrypts the authentication token received from the request receiver 121 and verifies whether the combination of the decrypted one-time key and user ID has been already issued (step S23). For ease of explanation, the description is given below of the case where the result of the verification in step S23 is positive, for example. The authentication unit 101 extracts the user ID from the decrypted authentication token and transmits the extracted user ID to the request receiver 121 (step S24).

Then, the request receiver 121 supplies the user ID received from the authentication unit 101 and the application ID included in the new registration request to the determiner 113 to request the determiner 113 to determine whether the user identified by the user ID is permitted to use the application identified by the application ID (step S25). The determiner 113 that has received this request determines whether the user identified by the user ID is permitted to use the application identified by the application ID, by using the user ID and the application ID supplied by the request receiver 121 (step S26). This processing is substantially the same as the processing of step S14 illustrated in FIG. 7.

For ease of explanation, the description is given below of the case where the result of the determination in step S26 is positive, for example. The determiner 113 transmits the determination result of step S26 to the request receiver 121 (step S27). The request receiver 121 that has received this determination result (positive determination result in this case) supplies the application ID included in the new registration request received in step S21 to the group ID acquirer 114 to request the group ID associated with the application ID (step S28). The group ID acquirer 114 that has received this request refers to the application association information and acquires the group ID associated with the application ID received from the request receiver 121 (step S29). Then, the group ID acquirer 114 transmits the acquired group ID to the request receiver 121 (step S30).

Then, the request receiver 121 supplies the application ID and the first data included in the new registration request received in step S21 and the group ID acquired in step S30 to the register 122 to request the register 122 to register data (step S31). The register 122 that has received this request supplies the group ID and the first data that are received from the request receiver 121 to the encryptor/decryptor 125 to request the encryptor/decryptor 125 to encrypt the first data (step S32). The encryptor/decryptor 125 that has received this request encrypts the first data by using an encryption key based on the group ID received from the register 122 to generate second data (step S33). If the new registration request includes a plurality of pieces of first data, a plurality of pieces of second that have one-to-one correspondence with the plurality of pieces of first data are generated.

After step S33, the encryptor/decryptor 125 transmits the second data generated in step S33 to the register 122 (step S34). Then, the register 122 issues a new record ID and registers, as a new record in the application data, a record in which the application ID and the first data supplied by the request receiver 121 and the second data supplied by the encryptor/decryptor 125 are associated with the issued record ID (step S35).

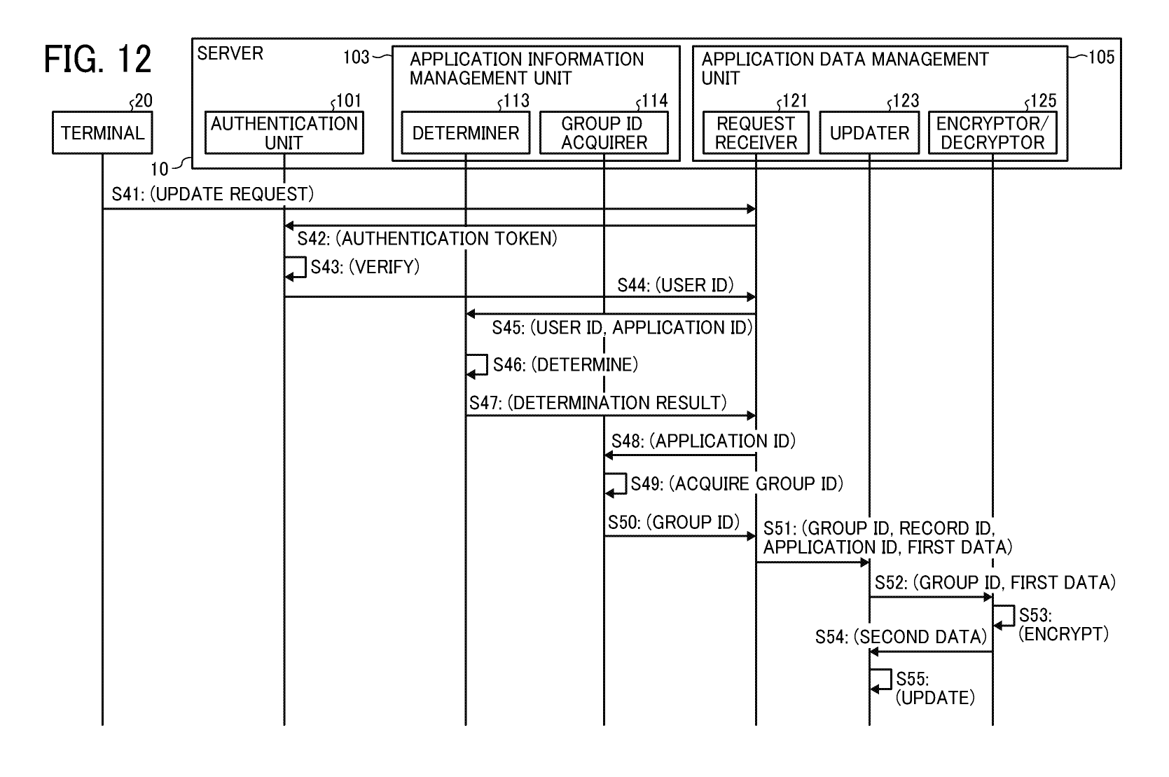

An example of a procedure of an operation performed by the system 100 when the authenticated user (user who has logged in) updates data (data in unit of record in this example) registered as data used by one of the applications will be described next with reference to FIG. 12.

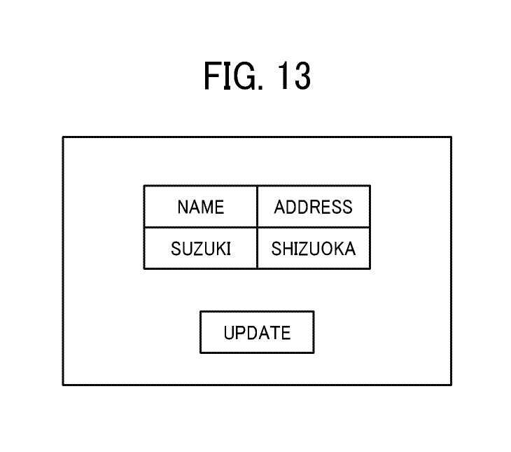

First, the authenticated user performs an operation for activing an update screen for updating (modifying) values (registered values) of respective items associated with a desired record, on the screen associated with the one of the applications. The authenticated user then performs an operation of changing the value of each item on the update screen and performs an operation for requesting updating of the data. For example, in the case of the application that manages the customer list, the user can perform an operation of changing values of respective items of “NAME” and “ADDRESS” on the update screen illustrated in FIG. 13 and then perform an operation of pressing an update button. The terminal 20 that has received this operation transmits, to the server 10, an update request including the input data (first data), the record ID for identifying the record to be updated, the authentication token (including the user ID) acquired from the server 10, and the application ID (of the one of the applications) (step S41).

Since processing of steps S42 to S50 is substantially the same as the processing of steps S22 to S30 illustrated in FIG. 10, a detailed description thereof is omitted. After step S50, the request receiver 121 supplies the record ID, the application ID, and the first data included in the update request received in step S41 and the group ID acquired in step S50 to the updater 123 to request the updater 123 to update the data (step S51). Since processing of steps S52 to S54 is substantially the same as the processing of steps S32 to S34 illustrated in FIG. 10, a detailed description thereof is omitted. After step S54, the updater 123 selects the record corresponding to the record ID supplied by the request receiver 121 from among the records included in the application data and updates the selected record to a record in which the record ID, the application ID, and the first data supplied by the request receiver 121 and the second data supplied by the encryptor/decryptor 125 are associated with one another (step S55). Specifically, the updater 124 updates each value included in the existing record to the corresponding value of the first data supplied by the request receiver 121 or the corresponding value of the second data supplied by the encryptor/decryptor 125.

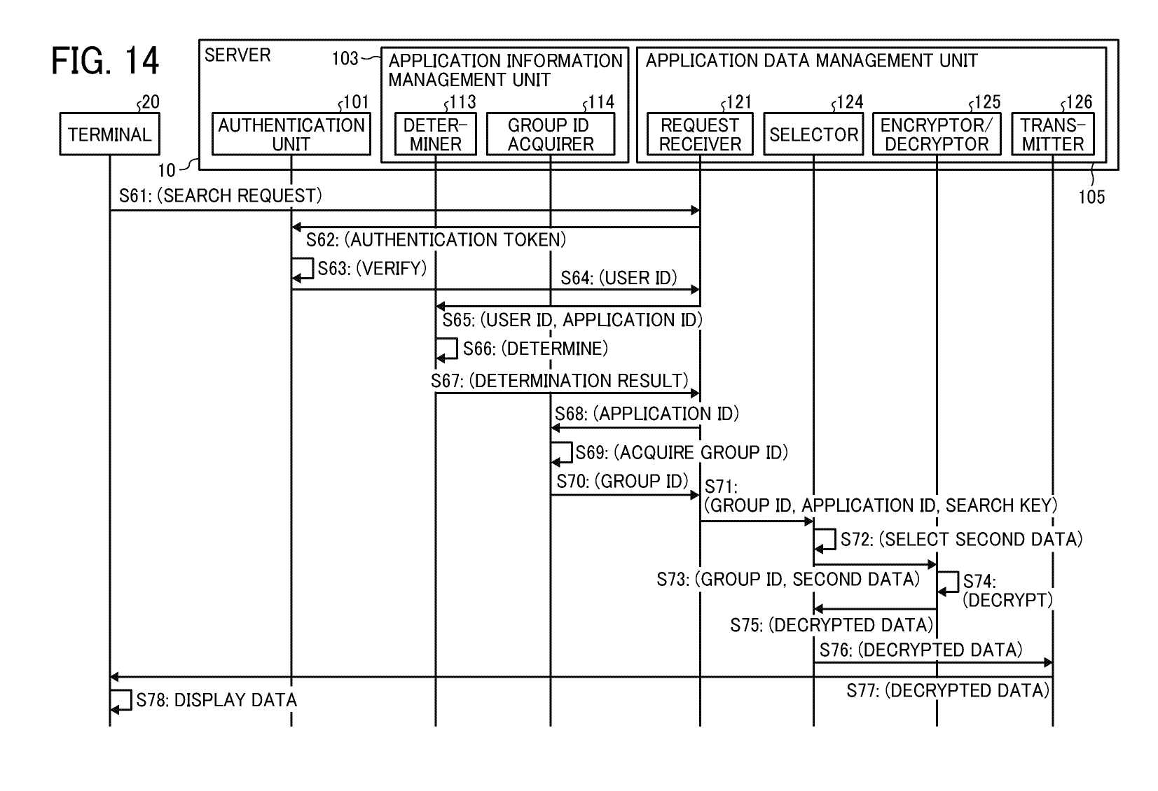

An example of a procedure of an operation performed by the system 100 in response to the authenticated user (user who has logged in) performing an operation for searching for data used by one of the applications will be described next with reference to FIG. 14.

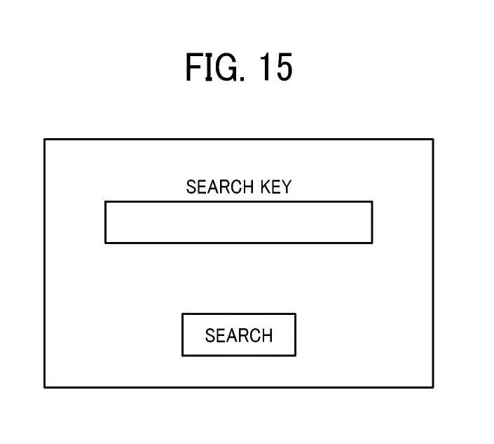

First, the authenticated user performs an operation for activating a data search screen for searching for data, on the screen associated with the one of the applications. The authenticated user then performs an operation of inputting a search key on the data search screen and performs an operation of requesting a data search. For example, the user can perform an operation of inputting a search key and then perform an operation of pressing a search button on the data search screen illustrated in FIG. 15. The terminal 20 that has received this operation transmits, to the server 10, a search request that includes the input search key, the authentication token (including the user ID) acquired from the server 10, and the application ID (of the one of the applications) (step S61).

Since processing of steps S62 to S70 is substantially the same as the processing of steps S22 to S30 illustrated in FIG. 10, a detailed description is omitted. After step S70, the request receiver 121 supplies the search key and the application ID included in the search request received in step S61 and the group ID acquired in step S70 to the selector 124 to request the selector 124 to search for the data (step S71). The selector 124 that has received this request selects the second data that is associated with the combination of the application ID received in step S71 and the first data that matches the search key received in step S71 from the application data (step S72). More specifically, the selector 124 selects all the records each including the application ID received in step S71 and the value (value not encrypted) that matches the search key received in step S71 from the application data and selects second data (the encrypted value corresponding to the second data in this case) included in the selected records.

Then, the selector 124 supplies the group ID received in step S71 and the second data selected in step S72 (which is not necessarily one piece and may be a plurality of pieces obviously) to the encryptor/decryptor 125 to request the encryptor/decryptor 125 to decrypt the second data (step S73). The encryptor/decryptor 125 that has received this request decrypts the second data received from the selector 124 by using an encryption key based on the group ID received from the selector 124 (step S74). Then, the encryptor/decryptor 125 supplies the decrypted data to the selector 124 (step S75). Then, the selector 124 supplies the decrypted data to the transmitter 126 to request the transmitter 126 to transmit the decrypted data to the terminal 20 (step S76). The transmitter 126 that has received this request transmits the decrypted data to the terminal 20 (step S77). The terminal 20 that has received the decrypted data as a response to the search request displays the received data as a search result (step S78).

As described above, the server 10 according to the embodiment does not create different databases for different groups. Instead, the server 10 performs collective management (collective management by using the combination of the application association information and the application data in the embodiment described above) by associating with one another the group ID, the application ID, the first data, and the second data obtained by encrypting the first data by using an encryption key based on the group ID. Consequently, data management becomes easier. In addition, in response to receiving a search request including a search key and an application ID, the server 10 according to the embodiment selects second data associated with a combination of the application ID included in the search request and the first data that matches the search key included in the search request. The server 10 then decrypts the selected second data by using an encryption key based on the corresponding group ID and returns the decrypted data alone as the search result to the terminal 20. That is, since the decrypted data alone is returned as the search result in the embodiment, data not encrypted does not leak to the outside as long as the encrypted data is successfully decrypted. Therefore, the embodiment can make data management easier and reduce the information leakage risk.

Although the server 10 having the functions illustrated in FIG. 3 is constituted by a single information processing device in the embodiment described above, the configuration is not limited to this one. For example, the functions illustrated in FIG. 3 may be implemented by a plurality of information processing devices in a distributed manner. That is, an information processing system including a plurality of information processing apparatuses may have the functions illustrated in FIG. 3.

In addition, the program executed by the system 100 described above (program executed by the CPU 11) may be provided after being stored as a file of an installable or executable format on a computer-readable recording medium, such as a Compact Display-Read Only Memory (CD-ROM), a flexible disk (FD), a CD-Recordable (CD-R), a Digital Versatile Disc (DVD), or a Universal Serial Bus (USB) flash drive or may be provided or distributed via a network, such as the Internet. In addition, various programs may be provided by pre-installing them in the ROM or the like.

The above-described embodiments are illustrative and do not limit the present invention. Thus, numerous additional modifications and variations are possible in light of the above teachings. For example, elements and/or features of different illustrative embodiments may be combined with each other and/or substituted for each other within the scope of the present invention.

Each of the functions of the described embodiments may be implemented by one or more processing circuits or circuitry. Processing circuitry includes a programmed processor, as a processor includes circuitry. A processing circuit also includes devices such as an application specific integrated circuit (ASIC), digital signal processor (DSP), field programmable gate array (FPGA), and conventional circuit components arranged to perform the recited functions.

1. An information processing apparatus comprising:
a first memory to store first association information that associates with one another group identification information for identifying a group, application identification information for identifying an application, first data not encrypted, and second data obtained by encrypting the first data by using an encryption key based on the group identification information;
circuitry to
select, in response to receiving a search request including the application identification information and a search key representing a character string to be searched for, the second data associated with a set of the application identification information included in the search request and the first data that matches the search key included in the search request, and
decrypt the selected second data by using the encryption key based on the group identification information to obtain decrypted data; and
a transmitter to transmit the decrypted data as a response to the search request.

2. The information processing apparatus according to claim 1, wherein the first association information includes
second association information that associates the group identification information and the application identification information with each other, and
third association information that associates, for each record representing a unit of stored information, record identification information for identifying the record, the application identification information, the first data, and the second data with one another.

3. The information processing apparatus according to claim 2, wherein the circuitry
acquires the group identification information associated with the application identification information included in the search request,
selects one or more records each including the application identification information included in the search request and the first data that matches the search key included in the search request,
selects the second data included in the one or more selected records, and
decrypts the selected second data by using an encryption key based on the group identification information.

4. The information processing apparatus according to claim 2, further comprising:
a second memory configured to store fourth association information that associates the group identification information and user identification information for identifying a user with each other,
wherein the search request further includes the user identification information, and
wherein the circuitry selects the second data when the group identification information associated with the user identification information included in the search request matches the group identification information associated with the application identification information included in the search request.

5. information processing apparatus according to claim 4, wherein in response to receiving a registration request that requests registration of new data, the registration request including the first data, the user identification information, and the application identification information,
the circuitry registers, in the third association information, a new record that associates with one another the first data included in the registration request, the second data obtained by encrypting the first data included in the registration request by using an encryption key based on the group identification information associated with the application identification information included in the registration request, and the record identification information of the new record.

6. The information processing apparatus according to claim 4, wherein in response to receiving an update request that requests updating of the record, the update request including the first data, the user identification information, the application identification information, and the record identification information,
the circuitry
updates the first data included in the record identified by the record identification information included in the update request to the first data included in the update request, and
updates the second data included in the record to the second data obtained by encrypting the updated first data by using an encryption key based on the group identification information associated with the application identification information included in the update request.

7. An information processing system comprising:
a first memory to store first association information that associates with one another group identification information for identifying a group, application identification information for identifying an application, first data not encrypted, and second data obtained by encrypting the first data by using an encryption key based on the group identification information;
one or more processors to:
select, in response to receiving, from a terminal, a search request including the application identification information and a search key representing a character string to be searched for, the second data associated with a combination of the application identification information included in the search request and the first data that matches the search key included in the search request;
decrypt the selected second data by using the encryption key based on the group identification information to obtain decrypted data; and
transmit the decrypted data to the terminal, as a response to the search request.

8. information processing system according to claim 7, wherein the first association information includes
second association information that associates the group identification information and the application identification information with each other, and
third association information that associates, for each record representing a unit of stored information, record identification information for identifying the record, the application identification information, the first data, and the second data with one another.

9. The information processing system according to claim 8, wherein the processors further
acquire the group identification information associated with the application identification information included in the search request,
select one or more records each including the application identification information included in the search request and the first data that matches the search key included in the search request,
select the second data included in the one or more selected records, and
decrypt the selected second data by using an encryption key based on the group identification information.

10. The information processing apparatus according to claim 8, further comprising:
a second memory to store fourth association information that associates the group identification information and user identification information for identifying a user with each other,
wherein the search request further includes the user identification information, and
wherein the processors select the second data when the group identification information associated with the user identification information included in the search request matches the group identification information associated with the application identification information included in the search request.

11. The information processing apparatus according to claim 10, wherein in response to receiving a registration request that requests registration of new data from the terminal, the registration request including the first data, the user identification information, and the application identification information,
the processors register, in the third association information, a new record that associates with one another the first data included in the registration request, the second data obtained by encrypting the first data included in the registration request by using an encryption key based on the group identification information associated with the application identification information included in the registration request, and the record identification information of the new record.

12. The information processing apparatus according to claim 10, wherein in response to receiving an update request that requests updating of the record from the terminal, the update request including the first data, the user identification information, the application identification information, and the record identification information,
the processors
update the first data included in the record identified by the record identification information included in the update request to the first data included in the update request, and
update the second data included in the record to the second data obtained by encrypting the updated first data by using an encryption key based on the group identification information associated with the application identification information included in the update request.

13. An information processing method, comprising:
storing, in a first memory, first association information that associates with one another group identification information for identifying a group, application identification information for identifying an application, first data not encrypted, and second data obtained by encrypting the first data by using an encryption key based on the group identification information;
selecting, in response to receiving a search request including the application identification information and a search key representing a character string to be searched for, the second data associated with a combination of the application identification information included in the search request and the first data that matches the search key included in the search request;
decrypting the selected second data by using the encryption key based on the group identification information to obtain decrypted data; and
transmitting the decrypted data as a response to the search request.

14. The information processing method according to claim 13, wherein the first association information includes
second association information that associates the group identification information and the application identification information with each other, and
third association information that associates, for each record representing a unit of stored information, record identification information for identifying the record, the application identification information, the first data, and the second data with one another.

15. The information processing method according to claim 14, further comprising:
acquiring the group identification information associated with the application identification information included in the search request;
selecting one or more records each including the application identification information included in the search request and the first data that matches the search key included in the search request;
selecting the second data included in the one or more selected records; and
decrypting the selected second data by using an encryption key based on the group identification information.

16. The information processing d according to claim 14, further comprising:
storing, in a second memory, fourth association information that associates the group identification information and user identification information for identifying a user with each other,
wherein the search request further includes the user identification information, and
wherein the selecting the second data is performed when the group identification information associated with the user identification information included in the search request matches the group identification information associated with the application identification information included in the search request.

17. The information processing method according to claim 16, further comprising:
receiving a registration request that requests registration of new data, the registration request including the first data, the user identification information, and the application identification information; and
registering, in the third association information, a new record that associates with one another the first data included in the registration request, the second data obtained by encrypting the first data included in the registration request by using an encryption key based on the group identification information associated with the application identification information included in the registration request, and the record identification information of the new record.

18. The information processing method according to claim 16, further comprising:
receiving an update request that requests updating of the record, the update request including the first data, the user identification information, the application identification information, and the record identification information;
updating the first data included in the record identified by the record identification information included in the update request to the first data included in the update request; and
updating the second data included in the record to the second data obtained by encrypting the updated first data by using an encryption key based on the group identification information associated with the application identification information included in the update request.
